(19) United States
(12) Patent Application Publication
(10) Pub. No.: US 2009/0271660 A1
(43) Pub. Date: Oct. 29, 2009

(54) MOTHERBOARD, A METHOD FOR RECOVERING THE BIOS THEREOF AND A METHOD FOR BOOTING A COMPUTER

(75) Inventors: Chung-Ta Chin, Taipei (TW); Shu-Jen Lin, Taipei (TW); Pei-Hua Sun, Taipei (TW); Ren-Shiang Tsai, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/333,314

(22) Filed: Dec. 12, 2008

(30) Foreign Application Priority Data
Apr. 28, 2008 (TW) 97115578

(51) Int. Cl. G06F 11/08; G06F 9/00

(52) U.S. Cl. 714/15; 713/2; 714/E11.03

(57) ABSTRACT

A motherboard, a method for recovering a BIOS thereof, and a method for booting a computer are provided. In the method for booting the computer, a first boot block of a first BIOS unit is executed first, and then a second boot block of a second BIOS unit is executed. Afterwards, BIOS main program codes of the second BIOS unit are executed. When the second BIOS unit is down, a recovery mechanism of the first boot block is used to overwrite data in the second BIOS unit with a backup file.

### CROSS-REFERENCE TO RELATED APPLICATION

This application claims the priority benefit of Taiwan application serial no. 97115578, filed on Apr. 28, 2008. The entirety of the above-mentioned patent application is hereby incorporated by reference herein and made a part of specification.

### BACKGROUND OF THE INVENTION

1. Field of the Invention

The present invention relates to a basic input output system (BIOS) of a computer and, more particularly, to a motherboard, a method for recovering the BIOS thereof and a method for booting a computer.

2. Description of the Related Art

BIOS program codes are generally stored in a flash memory. The flash memory storing the BIOS program codes, called BIOS unit herein, is assembled on the motherboard and is electrically connected with a south bridge chip of the motherboard through a bus. During operation, the BIOS program codes may be damaged inadvertently. For example, in the process of updating the BIOS program codes, sudden power failure may lead to the damage of the BIOS program codes, which makes the computer cannot be booted up normally. The users have to send the computer back to the original manufacturer to recover the BIOS program codes. However this increases the reconditioning cost of the original manufacturer.

### BRIEF SUMMARY OF THE INVENTION

The present invention provides a motherboard, a method for recovering the BIOS thereof and a method for booting a computer to improve the existing technical.

The method for booting the computer according to the invention includes the steps of executing first program codes of a first boot block of a first BIOS unit, executing second program codes of a second boot block of a second BIOS unit, and executing BIOS main program codes of the second BIOS unit.

The method for recovering the BIOS provided in the invention is adapted to a first BIOS unit and a second BIOS unit. The first BIOS unit includes a first boot block and a backup file. The second BIOS unit includes a second boot block and BIOS main program codes. The method for recovering the BIOS includes the steps of executing the first boot block, executing the second boot block, executing the BIOS main program codes, and overwriting the BIOS main program codes with the backup file when the BIOS main program codes are abnormal.

The motherboard provided in the invention is assembled in the computer system. The motherboard includes a chipset, a first BIOS unit and a second BIOS unit. The first BIOS unit is coupled with the chipset and includes a first boot block. The second BIOS unit is coupled with the chipset and includes a second boot block and BIOS main program codes. When the computer is booted up, the first boot block of the first BIOS unit is executed, and then the second boot block of the second BIOS unit is executed. Afterwards, the BIOS main program codes are executed.

The invention has beneficial effects. In the embodiment of the invention, two storage units are used to store the firmware for booting the computer. If the second BIOS unit is damaged by improper operations, by virtue of the mechanism of the first boot block of the first BIOS unit, users can recover the damaged second BIOS unit through an external flash memory or a floppy drive, or make the backup file of the first BIOS unit recover to the second BIOS unit automatically. According to this, the problem that the computer system cannot be booted up because of damage is avoided.

These and other features and advantages of the present invention will become better understood with regards to the following description, appended claims, and accompanying drawings.

### BRIEF DESCRIPTION OF THE DRAWINGS

FIG. 1 is a block diagram showing a computer system according to a first embodiment of the invention;

FIG. 2a is a functional block diagram showing two BIOS units according to the first embodiment of the invention;

FIG. 2b is a functional block diagram showing two BIOS units according to a second embodiment of the invention;

FIG. 3 is a flowchart showing a method for booting a computer system according to a preferred embodiment of the invention;

FIG. 4 is a flowchart showing a method for recovering a BIOS according to a preferred embodiment of the invention;

FIG. 5 is a block diagram showing a motherboard according to a preferred embodiment of the invention;

FIG. 6 is a block diagram showing a motherboard according to a third embodiment of the invention; and

FIG. 7 is a flowchart showing a method for recovering a BIOS according to the third embodiment of the invention.

### DETAILED DESCRIPTION OF THE EMBODIMENTS

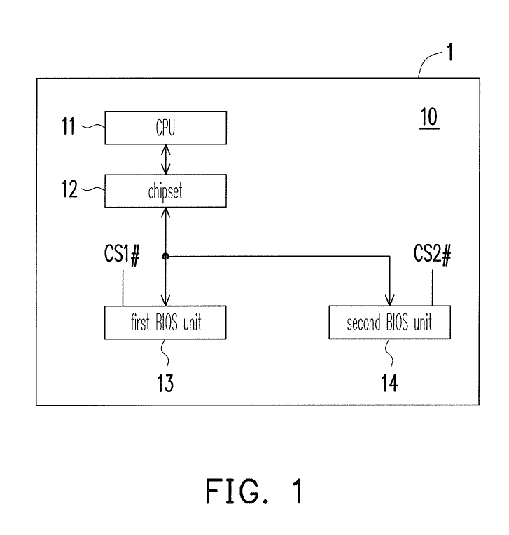

FIG. 1 is a block diagram showing a computer system according to a first embodiment of the invention. The computer system 1 provided in the embodiment includes a motherboard 10, a central processing unit (CPU) 11, a chipset 12, a first basic input output system (BIOS) unit 13 and a second BIOS unit 14.

The CPU 11, the chipset 12, the first BIOS unit 13 and the second BIOS unit 14 are assembled on the motherboard 10. In the embodiment, the chipset 12 includes a north bridge chip (not shown) and a south bridge chip (not shown). In other embodiments, the chipset 12 also may be integrated in the CPU 11.

The chipset 12 is respectively coupled with the CPU 11, the first BIOS unit 13 and the second BIOS unit 14. The second BIOS unit 14 is also coupled with the first BIOS unit 13.

In the embodiment, the first BIOS unit 13 and the second BIOS unit 14 are electrically connected with the chipset 12 through a transmission bus, respectively. For example, the first BIOS unit 13 is electrically connected with the chipset 12 through a first serial peripheral interface (SPI) bus, wherein the first SPI bus includes a first chip select line (CS1#); the second BIOS unit 14 is electrically connected with the chipset 12 through a second SPI bus, wherein the second SPI bus includes a second chip select line (CS2#). In FIG. 1, the first SPI bus and the second SPI bus are drawn together to simplify the diagram. The first chip select line and the second chip select line (CS2#) are drawn separately.

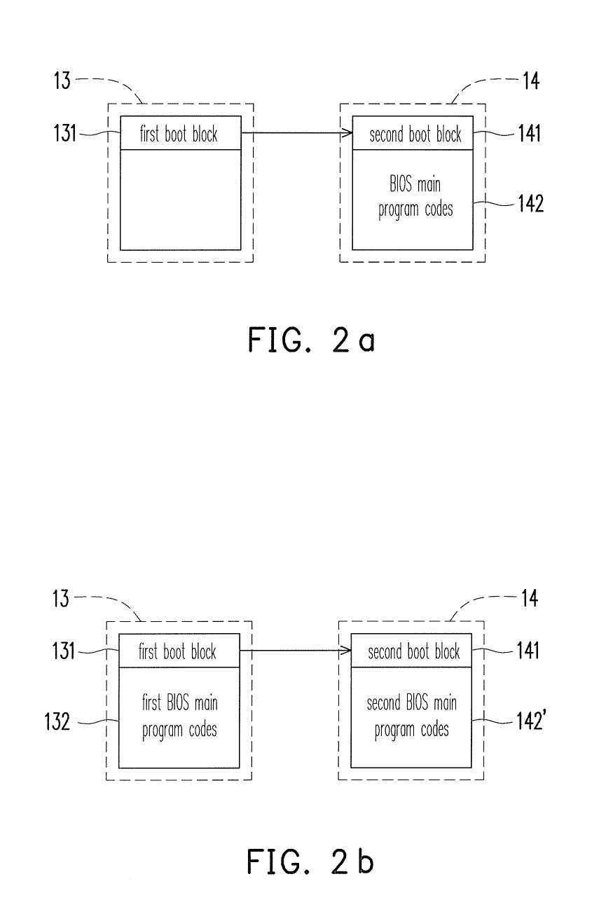

FIG. 2a is a functional block diagram showing two BIOS units according to the first embodiment of the invention. The first BIOS unit 13 includes a first boot block 131. The second BIOS unit 14 includes a second boot block 141 and BIOS main program codes 142.

When the computer system is booted up, the program codes of the first boot block 131 and the second boot block 141 are executed first, and they are responsible for the most basic and simplest initialization of the computer hardware. For example, the first boot block 131 is responsible for booting simpler system such as supporting the starting of a floppy drive and showing of graphic cards.

In the embodiment, the first boot block 131 and the second boot block 141 are respectively stored in the first BIOS unit 13 and the second BIOS unit 14. In the embodiment, the first boot block 131 of the first BIOS unit 13 cannot be updated, while the second boot block 141 of the second BIOS unit 14 can be updated. Furthermore, in the embodiment, the first BIOS unit 13 is coupled with the second BIOS unit 14 in series. Namely, after the computer system finishes executing the booting process in the first boot block 131 of the first BIOS unit 13, the computer system executes the second boot block 141 of the second BIOS unit 14.

Thereby when the second boot block 141 is damaged, the computer system can still be booted up through the first boot block 131 to recover the second boot block 141. When the BIOS main program codes 142 are damaged, the computer system can still be booted up through the first boot block 131 to recover the BIOS main program codes 142 by a floppy drive or other external storage devices.

FIG. 2b is a functional block diagram showing two BIOS units according to a second embodiment of the invention. In the embodiment, the first BIOS unit 13 includes a first boot block 131 and first BIOS unit main program codes 132. The second BIOS unit 14 includes a second boot block 141 and second BIOS unit main program codes 142′. When the second BIOS main program codes 142′ are damaged, the computer system can still use the first BIOS main program codes 132 to recover the second BIOS main program codes 142′.

In a preferred embodiment of the invention, the first BIOS unit 13 is a read only memory (ROM) to avoid overwriting or damaging the first boot block 131 or the first BIOS main program codes 132 in the first BIOS unit 13. In other embodiments, the first BIOS unit 13 also may be a non-volatile memory, such as a flash memory. In the preferred embodiment of the invention, the second BIOS unit 14 is a non-volatile memory in which data stored can be rewritten.

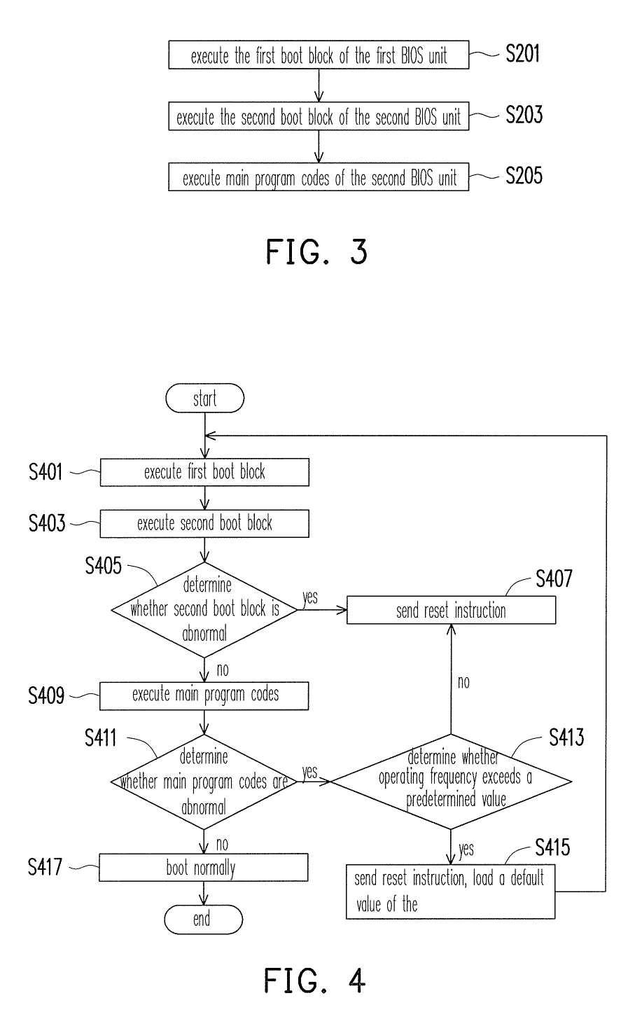

FIG. 3 is a flowchart showing the method for booting the computer according to a preferred embodiment of the invention. FIG. 3 is described with FIG. 1 and FIG. 2a.

When the computer system 1 is booted up, the first program codes of the first boot block 131 in the first BIOS unit 13 are executed (step S201).

Then, the computer system 1 executes the second program codes of the second boot block 141 in the second BIOS unit 14 (step S203). During executing, if the second boot block 141 is not abnormal, the computer system 1 executes BIOS main program codes 142 (step S205) to boot the computer.

When the computer system 1 executes the second boot block 141 of the second BIOS unit 14 or the BIOS main program codes 142, if the computer is down or has errors, the computer system 1 executes a reset instruction to update BIOS main program codes 142 through rebooting.

FIG. 4 is a flowchart showing the method for recovering the BIOS according to a preferred embodiment of the invention. The flowchart shows the steps of the method for recovering the BIOS when the computer system is down or has errors because of the damage of the BIOS program codes in the process of booting the computer.

As shown in FIG. 1, FIG. 2a and FIG. 4, when the computer system 1 is booted up, it executes the first boot block 131 of the first BIOS unit 13 first (step S401). Then, the computer system 1 jumps to the second BIOS unit 14 to execute the second boot block 141 (step S403).

Afterwards, the computer system 1 determines whether the second boot block 141 is abnormal (step S405). If yes, the computer system 1 automatically executes the reset instruction (step S407) to utilize a floppy drive, a CD-ROM drive or other external storage devices to recover the second boot block 141. If no, the computer system 1 executes BIOS main program codes 142 (step S409).

In other embodiments, when the computer system 1 determines that the second boot block 141 is abnormal, the computer system 1 automatically executes the reset instruction to utilize the first boot block 131 to recover the second boot block 141.

In the step S405, the computer system 1 can determine whether the second boot block 141 is abnormal through timing unit. In the embodiment, the timing unit is realized by software means, which has, for example, the program codes written in loop mode.

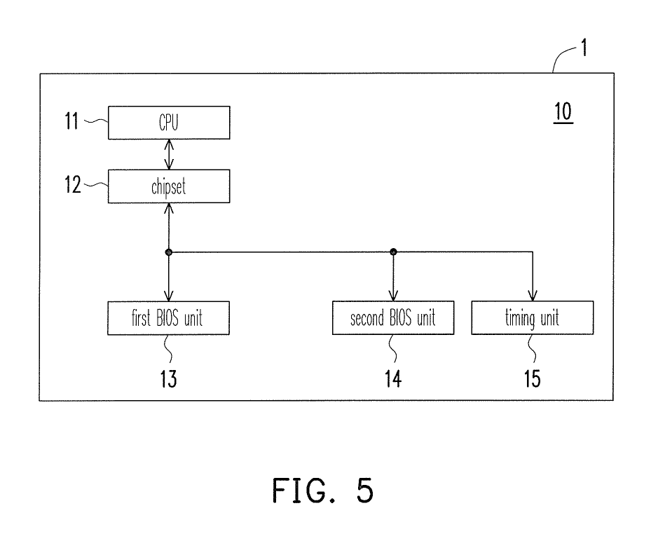

In other embodiments, the timing unit is realized by hardware as shown in FIG. 5. FIG. 5 is a block diagram showing the computer system according to a preferred embodiment of the invention. The timing unit 15 is coupled with the first BIOS unit 13 and the second BIOS unit 14, respectively. The timing unit 15 realized by hardware may be a resistance-capacitance (R-C) delay circuit or a reciprocal timer such as a watchdog timer.

For example, the computer system 1 can use the timing unit realized by hardware or software to determine whether the program codes of the second boot block 141 are executed within a predetermined time period. When the second boot block 141 is down or fails, the computer system 1 executes a rest instruction. For example, if the predetermined time period is four seconds, when the computer system 1 does not complete executing the second boot block 141 in four seconds, the computer system automatically executes the reset instruction.

In the step S411, the computer system 1 determines whether the BIOS main program codes 142 are abnormal. If the BIOS main program codes 142 are not abnormal to boot the computer, the computer system 1 starts operating system (step S417). If the BIOS main program codes 142 are abnormal, the computer system 1 determines whether the operating frequency of the CPU 11 exceeds a predetermined value (step S413).

Namely, in the step S413, the computer system 1 determines whether the overclocking of the CPU 11 causes the BIOS main program codes 142 to be executed abnormally. If the abnormality is caused by the overclocking, the computer system 1 executes the first reset instruction, and loads a default value of the operating frequency to make the computer system 1 operate normally (step S415).

Certainly, if the abnormality of the BIOS main program codes 142 is not caused by the overclocking, the computer system 1 executes the second reset instruction (return to the step S407) to recover the BIOS main program codes 142 by a floppy drives a CD-ROM drive or other external storage devices.

The first BIOS unit 13 can store a backup file. When the second BIOS unit 14 is down or damaged, the second BIOS unit 14 is recovered automatically by the backup file.

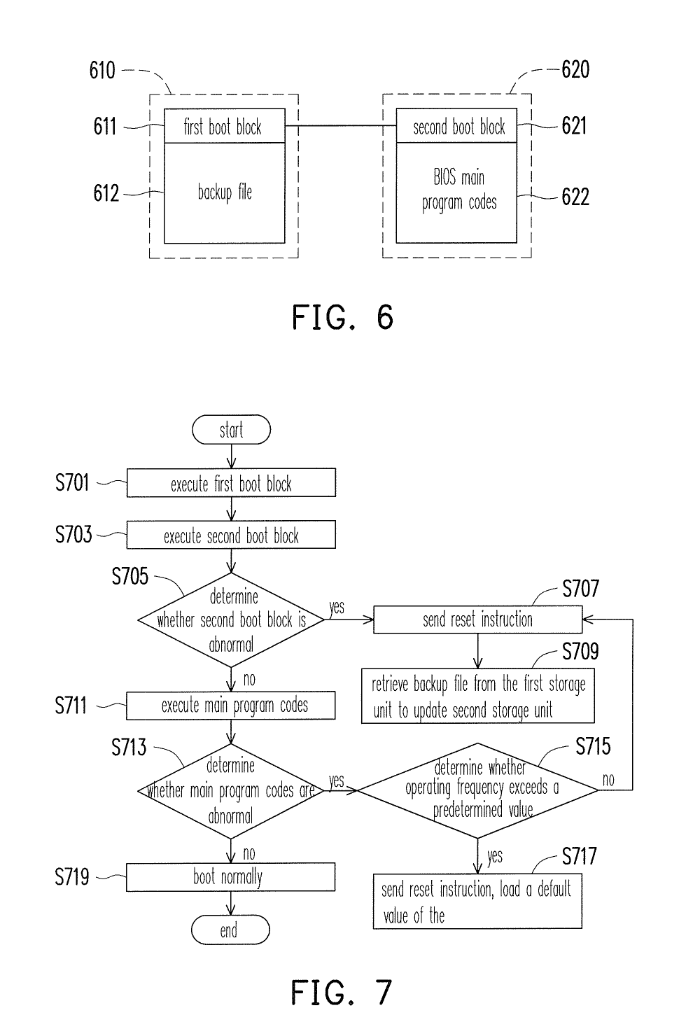

FIG. 6 is a block diagram showing a motherboard according to a third embodiment of the invention. The motherboard 6 according to the embodiment includes a first BIOS unit 610 and a second BIOS unit 620. The first BIOS unit 610 includes a first boot block 611 and a back up file 612, while the second BIOS unit 620 includes a second boot block 621 and BIOS main program codes 622. The difference between the motherboard 6 in the present embodiment and the motherboard 10 in the first embodiment is that the first BIOS unit 610 in the present embodiment further includes a backup file 612. Therefore, the motherboard 6 has a recovery function.

In detail, the first BIOS unit 610 has the backup file 612 such as a backup of the BIOS program codes besides the first boot block 611. Thereby the first BIOS unit 610 and the second BIOS unit 620 can be considered as firmware for booting the computer. When the second BIOS unit 620 is damaged, the first BIOS unit 610 recovers the backup file to the second BIOS unit 620 automatically. When the computer is booted up next time, the second BIOS unit 620 is recovered, and the process of executing the BIOS main program codes 622 remains the same: the first boot block 611 is executed first, and then the second boot block 621 and the BIOS main program codes 622 of the second BIOS unit 620 are executed.

FIG. 7 is a flowchart showing the method for recovering the BIOS according to the third embodiment of the present invention. As shown in FIG. 6 and FIG. 7, when the system with the assembled motherboard 6 is booted up, the system executes the first boot block 611 (step S701) first, and then the system executes the second boot block 621 (step S703).

In the step S705, the system determines whether the second boot block 621 is abnormal. If the second boot block 621 is abnormal, the system automatically executes the first reset instruction (step S707).

When the system determines that the second boot block 621 is abnormal after executing the reset instruction, the system automatically retrieves the backup file 612 from the first BIOS unit 610 to overwrite the second boot block 621 (step S709) to make the second boot block 621 execute normally.

If the second boot block 621 is normal, the system executes the BIOS main program codes 622 (step S711). In the step S713, the system determines whether the BIOS main program codes 622 are abnormal. If the BIOS main program codes 622 are normal, the system starts the operating system (step S719). If the BIOS main program codes 622 are abnormal, the system determines whether the operating frequency exceeds the predetermined value.

If the abnormality is caused by the overclocking, the system executes the reset instruction and loads a default value of the operating frequency of the CPU (step S717) to make the system operate normally. However, if the abnormality is not caused by the overclocking, the system also executes the second reset instruction (return to step S707). When the system determines that the second boot block 621 is abnormal, after the system executes the reset instruction, the system automatically retrieves the backup file 612 from the first BIOS unit 610 to overwrite the BIOS main program codes 622 (step S709). Thus, the BIOS main program codes 622 are executed normally.

To sum up, in the embodiment of the invention, when the second BIOS unit is damaged because of some improper operation, the first boot block of the first BIOS unit is used to recover the damaged second BIOS unit by an external storage device such as a flash memory or a floppy drive to automatically recover the backup program codes of the first BIOS unit to the second BIOS unit. Thus, the problem that the system cannot be booted up because of damage is avoided, and maintaining cost decreases.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for booting a computer, comprising:
executing a first program codes of a first boot block of a first BIOS unit;
executing a second program codes of a second boot block of a second BIOS unit; and
executing BIOS main program codes of the second BIOS unit.

2. The method for booting the computer according to claim 1, wherein when the second program codes of the second boot block are executed, the method further comprises:
determining whether the second program codes are executed within a predetermined time period; and
executing a first reset instruction to update the second boot block if the second program codes are not executed within the predetermined time period.

3. The method for booting the computer according to claim 1, wherein when the second program codes of the second boot block are executed, the method further comprises:
using a software means to determine whether the second program codes are executed; and
executing a first reset instruction to update the second boot block when the computer cannot be booted up normally.

4. The method for booting the computer according to claim 1, wherein after the step of executing the BIOS main program codes of the second BIOS unit, the method further comprises:
determining whether the BIOS main program codes are abnormal; and
executing a second reset instruction to update the BIOS main program codes when the BIOS main program codes are abnormal.

5. The method for booting the computer according to claim 4, wherein when the main program codes are abnormal, the method further comprises:
determining whether an operating frequency exceeds a predetermined value; and
sending the second reset instruction and loading a default value of the operating frequency when the operating frequency exceeds the predetermined value.

6. A method for recovering a BIOS adapted for a first BIOS unit and a second BIOS unit, wherein the first BIOS unit includes a first boot block and a backup file, and the second BIOS unit includes a second boot block and BIOS main program codes, the method comprising;
executing the first boot block;
executing the second boot block;
executing the BIOS main program codes; and
when the main program codes are abnormal, using the backup file to overwrite the main program codes.

7. The method for recovering the BIOS according to claim 6, wherein after the step of executing the second boot block, the method further comprises:
determining whether the second boot block is abnormal; and
when the second boot block is abnormal, executing a first reset instruction to update the second boot block.

8. The method for recovering the BIOS according to claim 7, wherein after the step of executing the first reset instruction to update the second boot block when the second boot block is abnormal, the method further comprises:
overwriting the second boot block of the second BIOS unit with a backup file.

9. The method for recovering the BIOS according to claim 6, wherein when the BIOS main program codes are abnormal, the step of overwriting the backup file to the main program codes comprises:
executing a second reset instruction to overwrite the main program codes of the BIOS with the backup file.

10. A motherboard assembled in a computer system, the motherboard comprising:
a chipset;
a first BIOS unit coupled with the chipset and including a first boot block; and
a second BIOS unit coupled with the chipset and the first BIOS unit and including a second boot block and BIOS main program codes,
wherein when the computer system is booted, the first boot block of the first BIOS unit is executed, the second boot block of the second BIOS unit is executed, and the BIOS main program codes are executed.

11. The motherboard according to claim 10, wherein the first BIOS unit further comprises a backup file; when the BIOS main program codes are abnormal, the backup file is used to overwrite the BIOS main program codes.

12. The motherboard according to claim 10, further comprising a timing unit, when the second boot block or the main program codes are executed, the timing unit begins to time to determine whether the second boot block or the BIOS main program codes are normal.

13. The motherboard according to claim 12, wherein the timing unit is coupled with the second BIOS unit and the timing unit is a resistance-capacitance (R-C) delay circuit or a reciprocal timer.

14. The motherboard according to claim 12, the timing unit is realized by software.
